(19) United States
(12) Patent Application Publication
(10) Pub. No.: US 2026/0262606 A1
(43) Pub. Date: Sep. 10, 2026

(54) A WASHING DEVICE FOR WASHING A DOMESTIC ANIMAL

(71) Applicant: Soosilla Ehitus OÜ, Viljandi linn (EE)

(72) Inventor: Renee Toomsalu, Soosilla, Kambja Vald (EE)

(73) Assignee: Soosilla Ehitus OÜ, Viljandi linn (EE)

(21) Appl. No.: 18/873,575

(22) PCT Filed: Jun. 16, 2023
(86) PCT No.: PCT/EP2023/066254

§ 371 Date: Dec. 10, 2024

(30) Foreign Application Priority Data
Jun. 20, 2022 (EP) 22179831.7

(51) Int. Cl. A01K 13/00

(52) U.S. Cl. CPC A01K 13/001

(57) ABSTRACT

A washing device for washing a dog, includes a washing tray including a base, one or more side walls and a first water outlet a height adjustable water distribution means including a first end connected to the washing tray and a second end positioned above the washing tray. The first end has a water inlet, and the second end includes a shower head.

### TECHNICAL FIELD

The present disclosure relates generally to the animal care products, more specifically to the washing devices for small domestic animals.

### BACKGROUND

Smaller domestic animals are for example rabbits, coats, pigs, dogs, cats, and other pets kept outdoors or indoors. Such animals are often kept in the gardens and taken to the walks on the streets or nature, where they get dirty. For the health of the pet or if the pet needs to be allowed inside the pet needs to be cleaned. In some cases, when the pet is playing outside in the garden or when the weather is rainy the pet may get very dirty and muddy, and thus cleaning with towel or the like is not sufficient and pet needs to be washed. Washing a pet may be challenging because many pets either don't like washing or there is something more exciting for them. In addition, washing a bet at regular shower room or bathroom is not hygienic.

Known pet washing devices are typically heavy weight metal constructions or stationary basin shower basins made of bricks which are not adjustable according to the pet's size, thus not suitable for home use for different pets in different sizes. Additional disadvantage of such devices is that the devices are not movable from one place to another, when, e.g., there is a need for garden maintenance, there is a need due to the weather conditions to move the device to some other location or due to some other reasons where it would be more convenient to wash and clean the pet.

For example, due to several reasons it may be for the pet more secure or more comfortable to move the washing device from one place to some other more suitable place. Such reasons may be too hot sun or other unpleasant weather conditions (e.g., wind, rain, snow), too much activities which distracts the pet, thus the device needs to be moved to the shadow, under the shelter or to some quiet place. Such various disturbing conditions may cause anxiety, nervousness or fear to the pet and therefore it is not possible to wash the pet because the pet wants to run away.

Thus, the known devices are not adjustable for different pets and are not possible to move from one place to another, e.g., from indoors to outdoors, use in different locations in gardens of private homes and summer cottages, and from outdoors to the indoors.

Therefore, in light of the foregoing discussion, there exists a need to overcome the aforementioned drawbacks associated with pet washing devices.

### SUMMARY

The aim of the present disclosure is to provide a washing device for washing a domestic animal which would be adjustable according to the size and needs of the domestic animal, wherein the domestic animal would feel safe, secure and calm during the washing procedure.

The aim of the disclosure is achieved by a washing device, which comprises a washing tray comprising a base, one or more side walls and a first water outlet; and a height adjustable water distribution means comprising a first end connected to the washing tray and a second end positioned above the washing tray, wherein the first end comprises a water inlet, and the second end comprises a shower head.

The advantage of the present washing device is that the washing device is adjustable for animals in different sizes, more specifically the washing device can be adjusted in height so that it would be suitable for smaller and bigger animals. This is especially advantageous when the pet, e.g., a dog, grows in size multiple times, thus the washing is more efficient as the height of the shower head can be adjusted according to the pet's height. In addition to the height of the shower head the angle of the shower head can be also adjusted, which enables to direct the flow of water in the desired direction. As the height and the angle of the shower head is adjustable, the washing device folded easily for moving or transporting to some other location or for storing purposes while the device is not in use.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the embodiments of the disclosure are shown in the drawings, with references to the following diagrams wherein:

FIG. 1 is an illustrative side view of a washing device in accordance with an embodiment of the present disclosure.

FIG. 2 is an illustrative front view of a washing device in accordance with an embodiment of the present disclosure;

FIG. 3 is an illustrative front view of a washing device in accordance with an embodiment of the present disclosure;

FIG. 3a shows the embodiment of FIG. 3, wherein the small size pet in the washing device according to the embodiments of the present disclosure is a dog, and

FIG. 4 is an illustrative side view of a washing device in accordance with an embodiment of the present disclosure.

### DETAILED DESCRIPTION OF EMBODIMENTS

The following detailed description illustrates embodiments of the present disclosure and ways in which they can be implemented.

In an aspect, an embodiment of the present disclosure provides a washing device for washing a dog, wherein the washing device comprises a washing tray comprising a base, one or more side walls and one or more first water outlets; a height adjustable water distribution means comprising a first end connected to the washing tray and a second end positioned above the washing tray, wherein the first end comprises a water inlet, and the second end comprises a shower head.

The domestic animal may be e.g., a rabbit, a coat, a lamb, a pig, a dog, a cat, and other pet who needs washing due to getting dirty. Like different domestic animals are in different sizes, having different height and weight, so are in different sizes, in different heights and weights, also the dogs. Thus, due to the different sizes of the dogs the wall of the washing tray in different embodiments may be lower or higher. Specifically, the “lower” and “higher” refers to a height of the walls of the washing tray according to the size of the pet so that the pet would be able to step into the washing device, that is for rabbits, pigs, cats, puppies and small dogs the walls of the washing tray are lower, i.e., suitable for their height and for coats, lambs, medium and bigger size dogs the walls of the washing tray are higher, i.e., suitable for their height. Higher walls of the washing tray have further advantage as in such embodiment the walls enable to accommodate water in the washing tray forming a washbasin, a bath or washtub like container. Such a container enables more efficient washing of the pet and provides for the pet also cooling option during hot weather.

The water inlet may alternatively be attached to the shower head at the second end of the height adjustable water distribution means. This enables easier assembling of the washing device.

The base of the washing tray is a stepping plate, i.e., a plate where the pet steps and on which the pet stands or sits during washing. In some embodiments, a surface of the base is at least partially covered with slipping prevention means. The slipping prevention means may be a roughened surface or the surface may comprise dots or the like to prevent slipping.

The height adjustable water distribution means enable to adjust the height of the washing device according to the pet's height. The height of the washing device is adjustable by moving the height adjustable water distribution means upwards and downwards. The height adjustable water distribution means can be adjusted so that the shower head of the height adjustable water distribution means is for example at height from 50 centimeter up to 140 centimeters (cm). Thus, the height adjustable water distribution means can be adjusted so that the shower head of the height adjustable water distribution means is from 50, 55, 60, 65, 70, 75, 80, 85, 90, 95, 100, 105, 110, 115, 120, 125, 130 or 135 cm up to 55, 60, 65, 70, 75, 80, 85, 90, 95, 100, 105, 110, 115, 120, 125, 130, 135 or 140 cm. The position of the height adjustable water distribution means can be adjusted either manually or automatically by an actuator.

In some embodiment, the water tray may comprise two or more first water outlets to ensure faster water drain of used water. This may be useful when it is needed to avoid collecting used dirty water into the water tray or to empty the water tank faster.

In the embodiments, the height adjustable water distribution means is formed of wrinkled hose or telescopic tube. Optionally, the wrinkled hose or telescopic tube may comprise foldable or telescopic housing. Alternatively, the hose or tube part of the height adjustable water distribution means may be formed of a bellows like structure. The water inlet is adapted to be connectable with e.g., a shower hose of the bathroom when the washing device is used indoors or e.g., a garden hose when the washing device is used outdoors.

Optionally, the washing device may comprise at the second end of the height adjustable water distribution means a joint connecting the shower head. The joint enables to adjust an angle of the shower head to regulate the angle of water flow of the shower at which the water is flowing. The joint enables to regulate the angle of water flow of the shower at which the water is flowing. The angle can be adjusted automatically or manually.

Optionally, the at least one of a height and an angle of the shower head is adjustable according to a height and a size of the dog. The adjustable height and angle allow the pet owner to direct the water flow to a preferred point on the dog, enhancing comfort and making showering and washing more efficient as the pet owner does not have to use hands to hold the shower head and can wash the dog's hair with both hands. It is also especially advantageous if the pet owner have two or more dogs in different heights and sizes, i.e., the pet owner can adjust the height of the washing device or angle of the shower head according to the dog's height and size. By adjusting the angle, the pet owner can direct the water flow for more effective rinsing, particularly useful when rinsing shampoo or soap out of the dog's hair.

In some embodiments, the base comprises a weight sensitive shower actuating means configurable to start the shower based on a weight of the dog. The shower actuating means enable to actuate the shower when the pet steps to the base. Optionally, the shower actuating means can be adjustable according to the pet's weight. The shower actuating means comprise a spring, hinge, joint or the like mechanism, which enables to open the water flow into the shower head. I.e., in some embodiments the base, i.e., the plate where the pet steps, may comprise adjustable springs that can be arranged to start the shower based on weight of the pet by adjusting the springs according to the pet's weight.

In some embodiments, the washing tray comprises a water tank underneath the base. The water tank enables to collect some water before the washing or during the washing to make the washing device heavier to stabilize the device and to avoid the washing device falling over. This is especially advantageous when the pet does not stay calm and steady but wants to move around during washing. Making the washing device temporarily heavier helps to stabilize the device also in the wind. Optionally, the water tank comprises one or more second water outlets. Water outlets enable emptying the tank, e.g., when the device needs to be moved or transported to another location, the tank can be emptied, by opening the water outlet and let the water to flow out, to make the device lighter and thus enable easier moving on transporting. In such embodiments wherein the washing device comprises a water tank the one or more second water outlets are lower than the first water outlet to enable adjusting the water level in the tank or water drain from the device. E.g., when the one or more second water outlets are closed then the water can be directed out from the washing device through the first water outlet by means of overflow but at the same time there is still water kept in the lower part of the tank which enables to keep the washing device stabilized.

In some embodiments, the base of the washing tray comprises a water drain. The washing drain enables the water to flow from the upper part of the base to the water tank underneath the base. This makes the washing more efficient as the dirty water can be directed out the washing try. Optionally, the water drain may comprise a water valve. The water valve enables opening and closing of the water drain to control the water flow out from the water tank.

To avoid letting pet's hair, dirt and mud to get into the water channel, in different embodiments, the at least one of the water drain, the first water outlet and the second water outlet may comprise a filter.

In some embodiments, the washing tray comprises height adjustable legs. The height adjustable legs enable to stabilize the washing device when the device is used on uneven ground. This can be achieved by adjusting the height of the legs. Thus, the height adjustable legs may be adjustable in height. This is advantageous in situations when the washing device is used on uneven ground, i.e., the height adjustable legs enable to adjust the angle of the washing tray by adjusting the height adjustable legs so that one or more height adjustable legs are longer or shorter than one or more of other height adjustable legs. This way it is ensured that the washing device is balanced and thus safe to use. Optionally, the height adjustable legs may additionally be attachable to the floor, ground or other base surface.

Optionally, in some embodiments, the washing device further comprises one or more of a drying means, a water heating means. The drying means can be e.g., a dryer for during the pet's fur. The water heating means may be attached to the water inlet to warm up the water if the washing device is connected with the garden hose.

Optionally, in some embodiments, the washing device may further comprises one or more of a shampoo holder, a sponge holder, a brush holder, a treats holder, a towel holder. The shampoo, the sponge, the brush help to make the washing more efficient. The treats holder for the treats may be needed to keep treats for calming down the pet during washing. The towel holder may be needed for the towel which can be used for drying the pet after washing. For the pet owner may be more comfortable if such means are on hand when washing the pet.

Optionally, the washing device may further comprise one or more actuators. The washing device may comprise a first actuator for starting the water flow automatically and the second actuator to adjust the height of the height adjustable water distribution means or the angle of the shower head automatically. This enables more efficient showering as the pet owner or the person who washed the pet can focus on washing and doesn't have to be worried about adjusting and regulating the washing device.

Optionally, the washing device may be equipped with solar panels to provide alternative or additional power supply to the washing device or it's components.

### DETAILED DESCRIPTION OF THE DRAWINGS

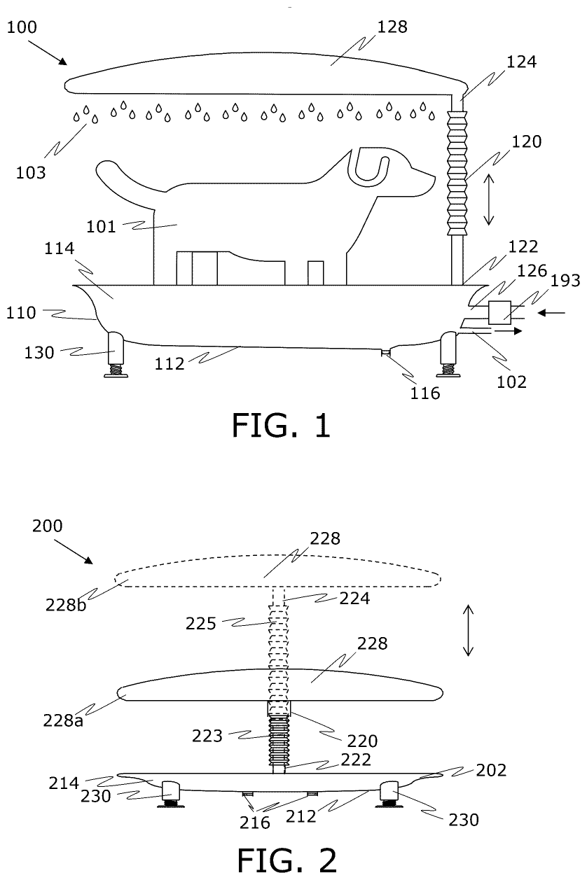

Referring to FIG. 1, there is shown an illustrative side view of a washing device in accordance with an embodiment of the present disclosure, wherein a pet, such as a medium size dog 101 is in the washing device 100. The washing device 100 for washing the dog 101, comprises a washing tray 110 comprising a base 112, one or more side walls 114 and a first water outlet 116 and a second water outlet 102 and height adjustable legs 130. The washing device further comprises a height adjustable water distribution means 120 formed of a wrinkled hose or telescopic tube comprising a first end 122 connected to the washing tray 110 and a second end 124 positioned above the washing tray, wherein the first end comprises a water inlet 126, and the second end comprises a shower head 128. The washing device further comprises one or more actuators 193.

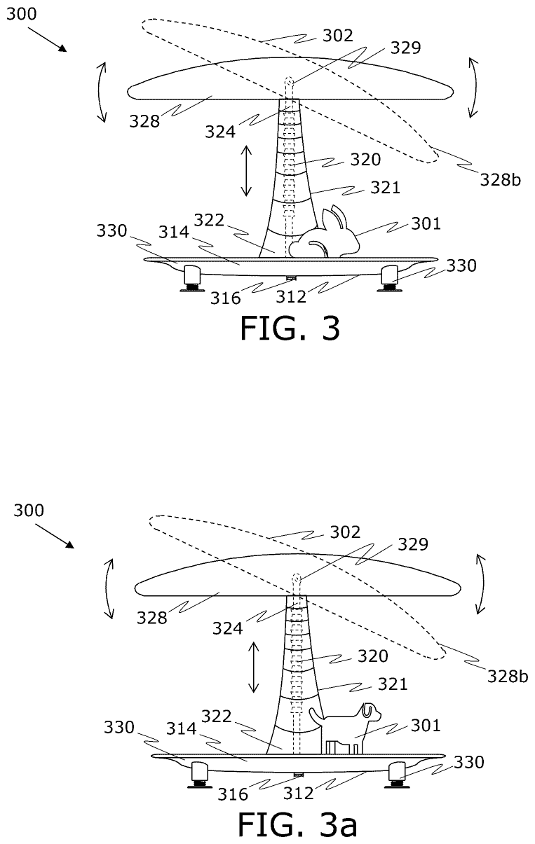

Referring to FIG. 2, there is shown an illustrative front view of a washing device 200 in accordance with an embodiment of the present disclosure, wherein the shower head 228 is shown in lower position 228a and higher position 228b, by changing the height of the height adjustable water distribution means 220 formed of a wrinkled hose or telescopic tube. The shower head is adjusted to the lower position when the adjustable part of the height adjustable water distribution means is in compressed position 223 and the shower head is adjusted to the higher position when the adjustable part of the height adjustable water distribution means is in elongated position 225. The embodiment of FIG. 2 further illustrates washing tray 210 having lower side walls 214 and two first water outlets 116.

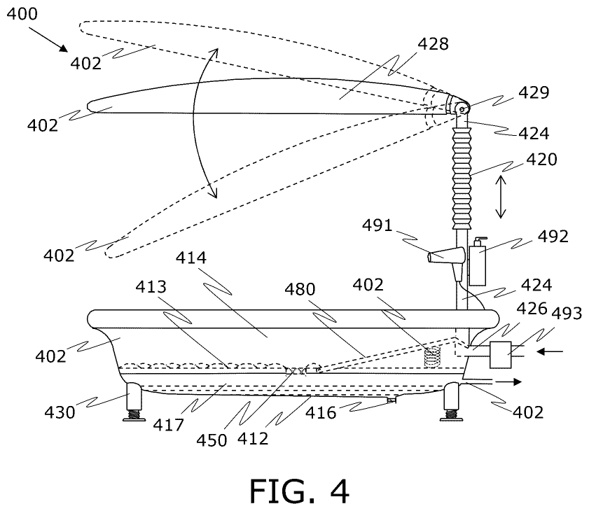

Referring to FIG. 3, there is shown an illustrative front view of a washing device 300 in accordance with an embodiment of the present disclosure, wherein a small size pet, such as a rabbit 301 is in the washing device 100. In the embodiment the washing device 300 comprises a washing tray 310 comprising a base 312, one or more side walls 314 and a first water outlet 316, a height adjustable water distribution means 320 formed of a wrinkled hose or telescopic tube comprising a first end 322 connected to the washing tray 310 and a second end 324 positioned above the washing tray, wherein the second end comprises a shower head 328 and wherein the wrinkled hose or telescopic tube is covered by foldable or telescopic housing 321. The second end 324 of the height adjustable water distribution means comprises a joint 329 connecting the shower head 328.

Referring to FIG. 3a, there is shown the embodiment of FIG. 3, wherein the small size pet in the washing device 100 is a dog 301.

Referring to FIG. 4, there is shown an illustrative side view of a washing device 400 in accordance with an embodiment of the present disclosure. The washing device 400 comprises a washing tray 410 comprising a base 412, one or more side walls 414 and a first water outlet 416, a height adjustable water distribution means 420 formed of wrinkled hose or telescopic tube comprising a first end 422 connected to the washing tray 410 comprising a water tank 417 and a second end 424 positioned above the washing tray, wherein the first end comprises a water inlet 426, and the second end comprises a shower head 428.

The base comprises shower actuating means 480 configurable to start the shower based on a weight of the dog and a base of the washing tray comprises a water drain 450 having a water valve 451. The water tank comprises one or more second water outlets 402. The second end 424 of the height adjustable water distribution means comprises a joint 429 connecting the shower head 428. A surface of the base is at least partially covered with slipping prevention means 413. The washing tray comprises height adjustable legs 430. In the embodiment, the washing device further comprises a drying means 491, a shampoo holder 492 and one or more actuators 493.

1. A washing device for washing a dog wherein the washing device comprises:
a washing tray comprising a base (112, 212, 312, 412), one or more side walls and one or more first water outlets;
a height adjustable water distribution means comprising a first end connected to the washing tray and a second end positioned above the washing tray, wherein the first end comprises a water inlet and the second end comprises a shower head; and
wherein the base comprises a weight sensitive shower actuating means configurable to start the shower based on a weight of the dog.

2. (canceled)

3. The washing device according to claim 1, wherein the height adjustable water distribution means is formed of wrinkled hose or telescopic tube.

4. The washing device according to claim 1, wherein the washing tray comprises a water tank underneath the base.

5. The washing device according to claim 1, wherein the water tank comprises one or more second water outlets.

6. The washing device according to claim 1, wherein the washing tray comprises a water drain.

7. The washing device according to claim 1, wherein the water drain comprises a water valve

8. The washing device according to claim 1, wherein the at least one of the water drain, the first water outlet and the second water outlet comprises a filter.

9. The washing device according to claim 1, wherein the second end of the height adjustable water distribution means comprises a joint connecting the shower head.

10. The washing device according to claim 1, wherein a surface of the base is at least partially covered with slipping prevention means, wherein the slipping prevention means is a roughened surface or a surface comprising dots.

11. The washing device according to claim 1, wherein the washing tray comprises height adjustable legs.

12. The washing device according to claim 1, wherein the washing device further comprises one or more of a drying means, a water heating means.

13. The washing device according to claim 1, wherein the washing device further comprises one or more of a shampoo holder, a sponge holder, a brush holder, a treats holder, a towel holder.

14. The washing device according to claim 1, wherein the washing device further comprises one or more actuators selected from a first actuator for starting the water flow automatically and a second actuator to adjust the height of the height adjustable water distribution means or an angle of the shower head automatically.

15. The washing device according to claim 1, wherein at least one of a height and an angle of the shower head is adjustable according to a height and a size of the dog.
